(19) United States
(12) Patent Application Publication
(10) Pub. No.: US 2016/0165025 A1
(43) Pub. Date: Jun. 9, 2016

(54) HOLDER FOR CLAMPING AND WIRELESSLY TRIGGERING MOBILE TERMINAL DEVICE

(71) Applicant: ORtek Technology, Inc., New Taipei City (TW)

(72) Inventors: Uen-Hour SHEU, New Taipei City (TW); Chi-Te HUANG, New Taipei City (TW)

(73) Assignee: ORtek Technology, Inc., New Taipei City (TW)

(21) Appl. No.: 14/600,312

(22) Filed: Jan. 20, 2015

(30) Foreign Application Priority Data
Dec. 8, 2014 (TW) 103221711

(51) Int. Cl. H04M 1/04; H04M 1/725

(52) U.S. Cl. CPC H04M 1/04; H04M 1/7253

(57) ABSTRACT

The present invention is to provide a holder for clamping and wirelessly triggering a mobile terminal device, which includes a fixed portion, a slidable portion having one end movably inserted in the fixed portion such that a clamping space is formed therebetween and serves to receive the mobile terminal device clamped therein, an elastic portion mounted in the fixed portion and corresponding to the slidable portion so as to apply a force to the slidable portion for adjusting the clamping space, and a controller having one side movably mounted to the fixed portion and a button provided on the top side thereof. When wireless connection is established between the controller and the mobile terminal device, a press on the button causes the controller to generate a control signal, send the control signal to the mobile terminal device, and thereby trigger the mobile terminal device to perform a corresponding procedure.

### FIELD OF THE INVENTION

The present invention relates to a holder, more particular to a holder for clamping and wirelessly triggering a mobile terminal device, which includes a fixed portion, a slidable portion having one end movably inserted in the fixed portion such that a clamping space is formed therebetween and serves to receive the mobile terminal device clamped therein, an elastic portion mounted in the fixed portion and corresponding to the slidable portion so as to apply a force to the slidable portion for adjusting the clamping space, and a controller having one side movably mounted to the fixed portion and a button provided on the top side thereof. When wireless connection is established between the controller and the mobile terminal device, a press on the button causes the controller to generate a control signal, send the control signal to the mobile terminal device, and thereby trigger the mobile terminal device to perform a corresponding procedure (e.g., taking a picture).

### BACKGROUND OF THE INVENTION

With the advancement of the electronics industry, mobile terminal devices such as smartphones and tablet computers have been continually improved in portability and functionality. For example, smartphones nowadays are practically a basic means of communication, and in order to secure a position in the market, smartphone manufacturers have spared no effort in responding to consumers' pursuit for change and novelty. Not only are smartphones made thinner and lighter to meet the trend for compactness, but also a variety of functions in addition to making phone calls and sending/receiving text messages are incorporated into a single handset. Such additional functions (e.g., taking pictures, video recording, Internet connection, games, and receiving/playing radio broadcasts) are intended to win consumers' favor by substantially enhancing convenience of use, allowing a person to carry only one smartphone with them instead of a number of different electronic devices.

Of the various functions of smartphones, picture taking is the most favored. The main reason for this lies in the ever-increasing storage capacity and the constantly upgraded lens quality of smartphones. In fact, the lens specifications of smartphones are even superior to those of most consumer cameras. As a result, consumer cameras are being replaced by smartphones. Apart from that, the wide availability of wireless networks and the prevalence of social networking websites have enabled smartphone users to take pictures of whatever in their daily lives and upload the pictures to social networking websites in order to share the pictures with family and friends. In particular, today's smartphones are typically provided with a front camera so that, besides taking pictures of scenery and food, smartphone users can include themselves in the pictures taken. This has given rise to the global trend of taking pictures of oneself—a phenomenon so prominent that the word “selfie”, meaning a photograph that one takes of oneself, was chosen by Oxford Dictionaries in 2013 as Word of the Year.

Selfies add to the fun of life and also serve as a record of life. As the screen of a smartphone can instantaneously display a picture just taken, smartphone users can easily capture their confident looks with the built-in camera and control the feel of their selfies. In view of this, picturing-taking application software and auxiliary equipment were developed, with the hope of creating new markets out of the selfie phenomenon. Generally speaking, one who tries to take a selfie with a smartphone would extend the smartphone-holding hand as far as possible to increase the field of view of the phone camera and thereby include more scenery in the picture. Due to the limited length of the arm, however, the smartphone user's face tends to occupy so large an area of the picture that much of the scenery behind the user is left out. To solve this problem, a selfie taking device 1 as shown in FIGS. 1 and 2 was designed whereby one who wishes to take a selfie with a smartphone 2 can put the smartphone 2 as far away as possible. The selfie taking device 1 includes a clamping base 11, a holding stick 13, and a remote control 15 (see FIG. 2). The clamping base 11 is provided with a positioning table 111 and a sliding rack 113. Two extension tubes 112 extend upward from the top side, and are adjacent to the rear, of the positioning table 111. The sliding rack 113 is of an inverted U shape and has two bottom ends respectively and movably inserted in the extension tubes 112 such that a clamping space 114 is formed between the top end of the sliding rack 113 and the top side of the positioning table 111. The sliding rack 113 can slide upward and downward along the extension tubes 112 to change the height of the clamping space 114 (as indicated by the dashed lines in FIG. 2).

As shown in FIGS. 1 and 2, the holding stick 13 has one end locked to the bottom side of the positioning table 111. A user can hold any other part of the holding stick 13 as needed to change the distance of the clamping base 11 from the user. Once the smartphone 2 is placed in the clamping space 114 and fixed to the clamping base 11 via the sliding rack 113, the user can keep the smartphone 2 a great distance away simply by holding the holding stick 13. In the meantime, the image to be taken by the smartphone 2 can also be adjusted with ease. Since the user holding the holding stick 13 cannot reach, let alone press, the buttons on the smartphone 2, it is necessary to connect the remote control 15 to the smartphone 2 in advance so that the smartphone 2 can be controlled by the remote control 15 to take pictures.

Through long-term observation, however, the applicant has found certain drawbacks of the selfie taking device 1 during use, as stated below with reference to FIGS. 1 and 2. First of all, the fact that the remote control 15 is a separate component requires the user to store the clamping base 11 and the remote control 15 separately while carrying the selfie taking device 1 around. If the user forgets to carry the remote control 15 with him or her, the selfie taking device 1 simply cannot be used to take selfies. Furthermore, when a close-up selfie is desired, the distance required between the smartphone 2 and the user is generally no greater than the arm's length, but with the clamping base 11 pressed against the smartphone 2, it is difficult for the user to hold the clamping base 11. The user therefore has to detach the smartphone 2 from the clamping base 11 before taking the close-up, which is rather inconvenient. Last but not least, the smartphone 2 is designed to be pressed against the clamping base 11 by the sliding rack 113 alone. So, if the user fails to fix the smartphone 2 properly to the clamping base 11, the smartphone 2 may fall off the clamping base 11 or even get damaged when the holding stick 13 is held at an angle.

In light of the various drawbacks of the selfie taking device 1 shown in FIGS. 1 and 2, a new product which is based on the principle of user-friendliness in industrial design and which makes it easier to take selfies with a mobile terminal device such as a smartphone or tablet computer is highly desired by consumers and manufacturers alike.

### BRIEF SUMMARY OF THE INVENTION

To effectively overcome the aforesaid drawbacks of the existing selfie taking devices, the inventor of the present invention incorporated years of practical experience into repeated experiments and tests and finally succeeded in developing a holder for clamping and wirelessly triggering a mobile terminal device.

It is an objective of the present invention to provide a holder for clamping and wirelessly triggering a mobile terminal device so that a user can operate the mobile terminal device conveniently with the holder. The holder includes a fixed portion, a slidable portion, an elastic portion, and a controller. The fixed portion is formed with a vertically extending extension base, and the bottom edge of the extension base is formed with a forwardly extending first clamping portion. The extension base and the first clamping portion are connected together as a single unit. The slidable portion is formed with a vertically extending extension plate, and the top edge of the extension plate is formed with a forwardly extending second clamping portion. The extension plate and the second clamping portion are connected together as a single unit. The bottom end of the extension plate is movably inserted in the extension base so that the extension plate can slide upward and downward with respect to the extension base. The second clamping portion corresponds to the first clamping portion such that a clamping space is formed between the clamping portions. The clamping space serves to receive a mobile terminal device clamped therein. The elastic portion includes a mounting base and an elastic restoring member. The mounting base is mounted in the fixed portion and corresponds to the bottom edge of the extension base. The elastic restoring member has one end connected to the mounting base and another end connected to the extension plate at a position adjacent to the bottom end of the extension plate. When a force is applied to the slidable portion to displace the slidable portion away from the fixed portion, the clamping space between the second clamping portion and the first clamping portion expands so as to receive the mobile terminal device. Once the force is removed, the elastic restoring member generates a restoring force acting on the extension plate, and the slidable portion is forced toward the fixed portion by the restoring force until the mobile terminal device is securely clamped between the first clamping portion and the second clamping portion, or more particularly until the first clamping portion and the second clamping portion are pressed against the two corresponding sides of the mobile terminal device respectively. The controller has one side movably mounted to the rear side of the extension base, and a button is provided on the top side of the controller. When wireless connection is established between the controller and the mobile terminal device, a press on the button causes the controller to generate a control signal, send the control signal to the mobile terminal device, and thereby trigger the mobile terminal device to perform a corresponding procedure (e.g., taking a picture). The user only has to adjust the slidable portion, and the clamping space can be easily enlarged or reduced to adapt to mobile terminal devices of different sizes. Moreover, the user can perform wireless remote control via the controller and thereby trigger the mobile terminal device to take pictures. Compared with the prior art devices, the present invention features increased convenience of use.

### BRIEF DESCRIPTION OF THE SEVERAL VIEWS OF THE DRAWINGS

The above and other objectives as well as the technical features and effects of the present invention will be best understood by referring to the following detailed description of some illustrative embodiments in conjunction with the accompanying drawings, in which:

FIG. 1 schematically shows a conventional selfie taking device;

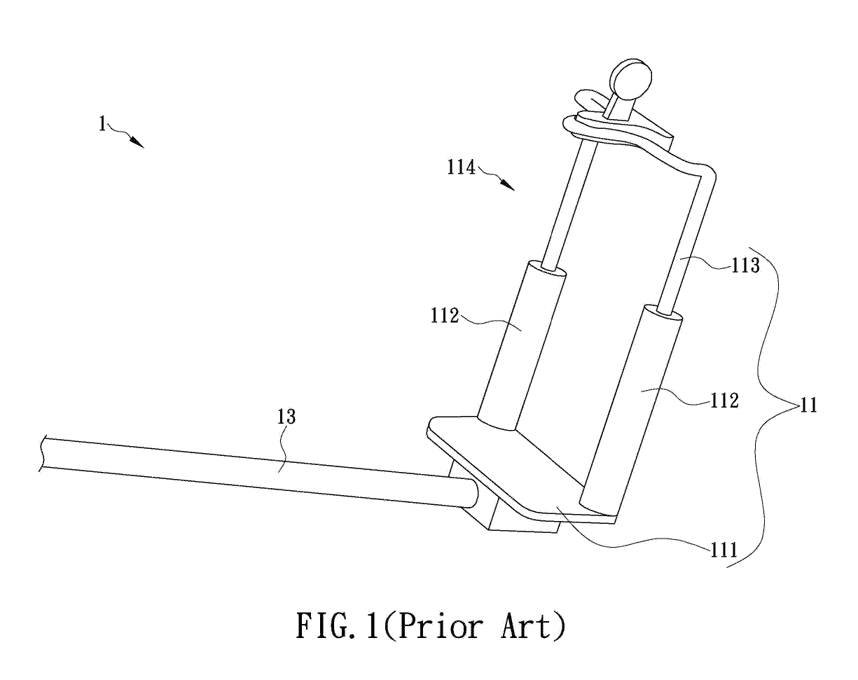

FIG. 2 schematically shows how a conventional selfie taking device is used with a smartphone;

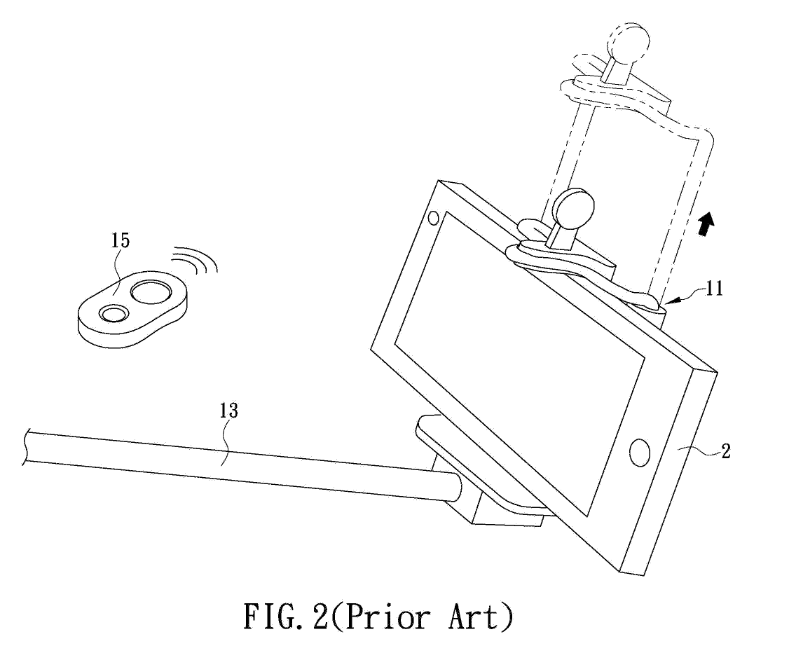

FIG. 3 is an exploded front view of a holder according to the present invention;

FIG. 4 is an exploded rear view of the holder shown in FIG. 3;

FIG. 5 is an assembled view of the holder shown in FIG. 3; and

FIG. 6 schematically shows how the holder in FIG. 3 is used with a mobile terminal device.

### DETAILED DESCRIPTION OF THE INVENTION

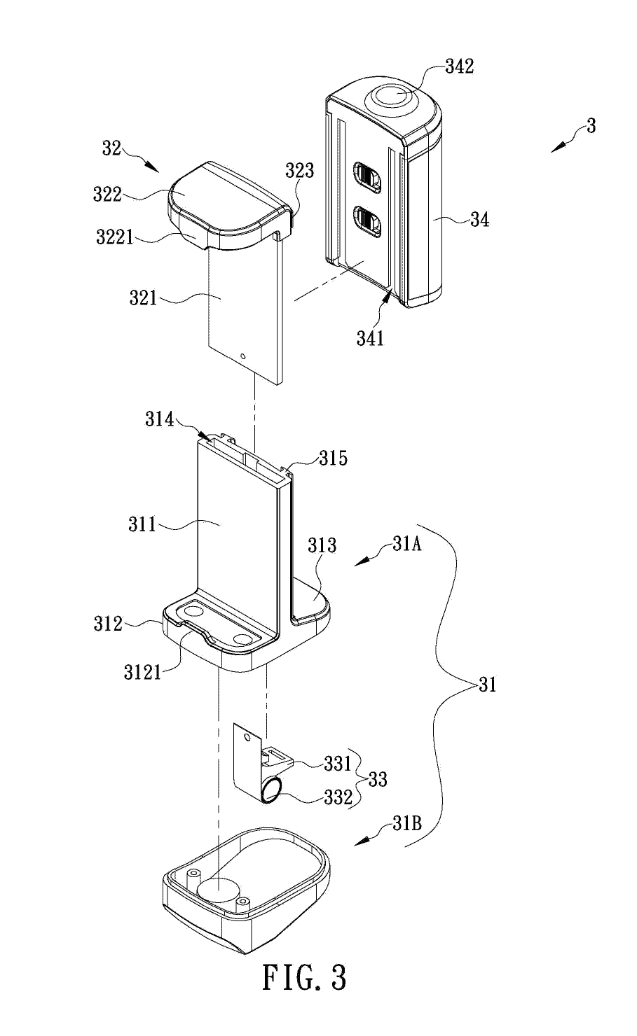

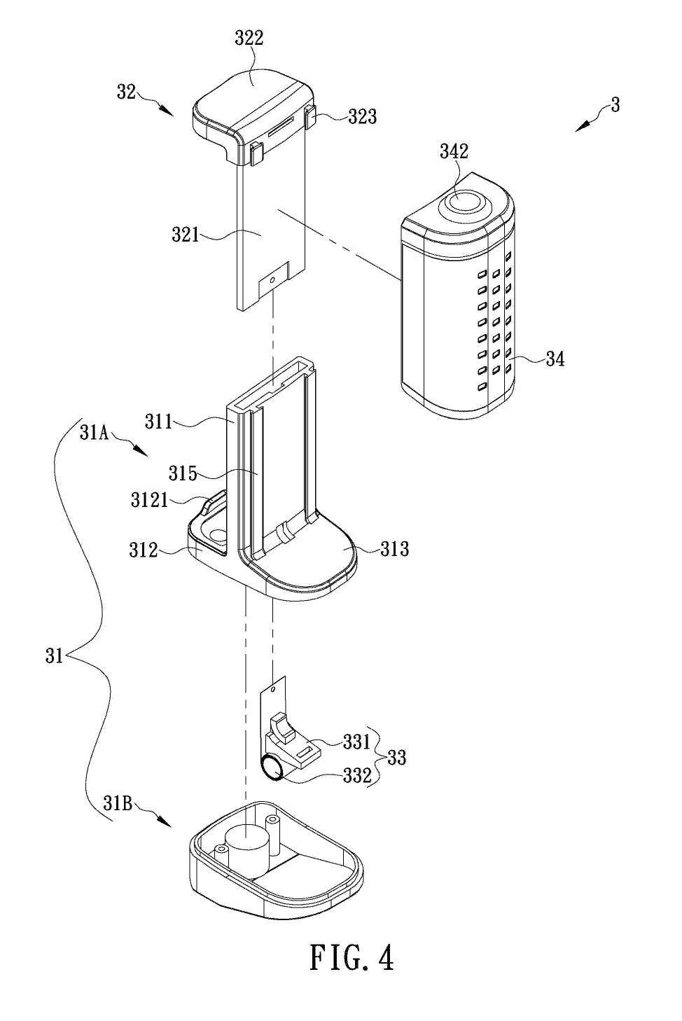

The present invention provides a holder for clamping and wirelessly triggering a mobile terminal device. Please refer to FIGS. 3 and 4, in which the direction facing the lower left corner of FIG. 3 is defined as the front direction, the direction facing the upper right corner of FIG. 3 is defined as the rear direction, the direction facing the upper left corner of FIG. 3 is defined as the leftward direction, the direction facing the lower right corner of FIG. 3 is defined as the rightward direction, the direction facing the top of FIG. 3 is defined as the upward direction, and the direction facing the bottom of FIG. 3 is defined as the downward direction. The holder 3 in this embodiment includes a fixed portion 31, a slidable portion 32, an elastic portion 33, and a controller 34. The fixed portion 31 is formed with a vertically extending extension base 311, and the extension base 311 has a bottom edge formed with a forwardly extending first clamping portion 312 and a rearwardly extending supporting portion 313. The extension base 311, the first clamping portion 312, and the supporting portion 313 are connected together as a single unit. In addition, the top edge of the extension base 311 is concavely provided with a groove 314 which extends through the extension base 311, and the rear side of the extension base 311 is protrudingly provided with two rails 315 which extend vertically from the top edge of the extension base 311 to a position adjacent to the joint between the extension base 311 and the supporting portion 313. Moreover, the top side of the first clamping portion 312 is upwardly protrudingly provided with a first positioning block 3121 adjacent to the front of the first clamping portion 312. In other embodiments of the present invention, however, the supporting portion 313 can be dispensed with, the number of the rails 315 can be adjusted to only one or more than two, or the first positioning block 3121 can be omitted, with a view to meeting production or design requirements.

It should be pointed out that, in the embodiment shown in FIGS. 3 and 4, the fixed portion 31 is assembled from a first fixed base 31A and a second fixed base 31B. More specifically, the first fixed base 31A and the second fixed base 31B are put together vertically to form the first clamping portion 312 and the supporting portion 313. In other embodiments of the present invention, however, the first fixed base 31A and the second fixed base 31B can be so designed that they are assembled along the front-rear direction, and in that case, the first fixed base 31A is provided with the first clamping portion 312 while the second fixed base 31B is provided with the supporting portion 313. Alternatively, the first fixed base 31A and the second fixed base 31B can be so designed that they are assembled along the leftward-rightward direction, or the fixed portion 31 can be designed as a single integral unit. In short, the fixed portion 31 can be arbitrarily adjusted according to production, assembly, or design requirements.

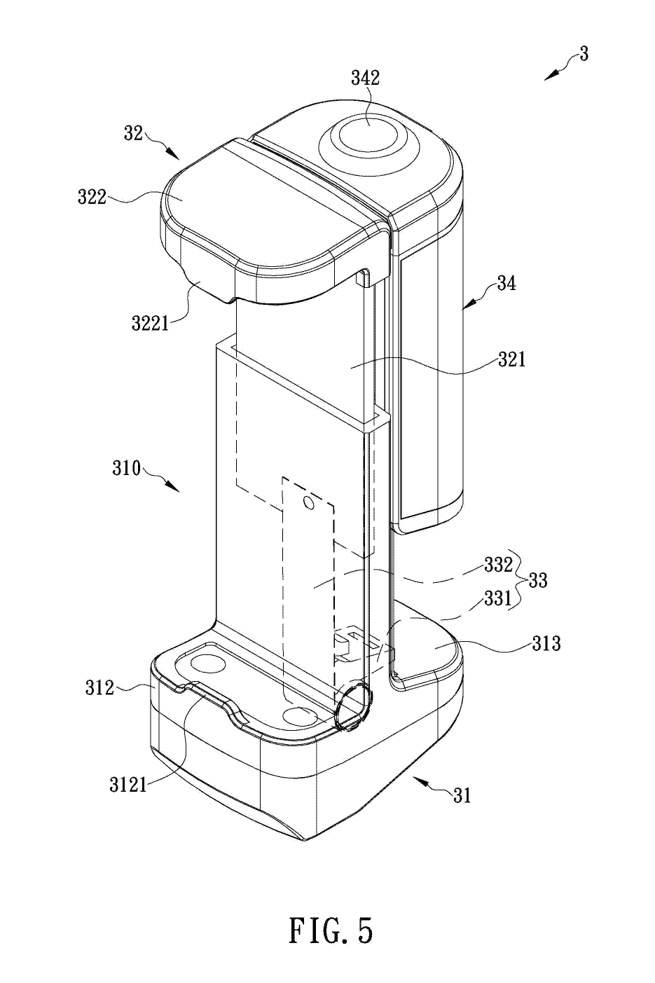

Referring again to FIGS. 3 and 4, the slidable portion 32 is formed with a vertically extending extension plate 321, and the top edge of the extension plate 321 is formed with a forwardly extending second clamping portion 322. The extension plate 321 and the second clamping portion 322 are connected together as a single unit. Also, the bottom side of the second clamping portion 322 is downwardly protrudingly provided with a second positioning block 3221 adjacent to the front of the second clamping portion 322. Once the slidable portion 32 is mounted to the fixed portion 31, the bottom end of the extension plate 321 is movably inserted in the groove 314 so that the extension plate 321 can slide upward and downward along the groove 314. Moreover, with the second clamping portion 322 corresponding to the first clamping portion 312, a clamping space 310 (see FIG. 5) is formed between the two clamping portions. In addition, the rear side of the second clamping portion 322 is protrudingly provided with two engaging blocks 323, which respectively correspond to and have the same cross-sectional configuration as the rails 315. Thus, when the extension plate 321 is fully inserted in the groove 314, the bottom edge of the second clamping portion 322 is pressed against the top edge of the extension base 311, and the bottom edges of the engaging blocks 323 are pressed against the top edges of the rails 315 respectively. In other embodiments of the present invention, however, it is also feasible to adjust the number of the engaging blocks 323 to only one or more than two or dispense with the second positioning block 3221. The extension plate 321 and the extension base 311 can be connected by other means as well, i.e., without the groove 314 in the extension base 311, provided that the extension plate 321 can slide upward and downward with respect to the extension base 311.

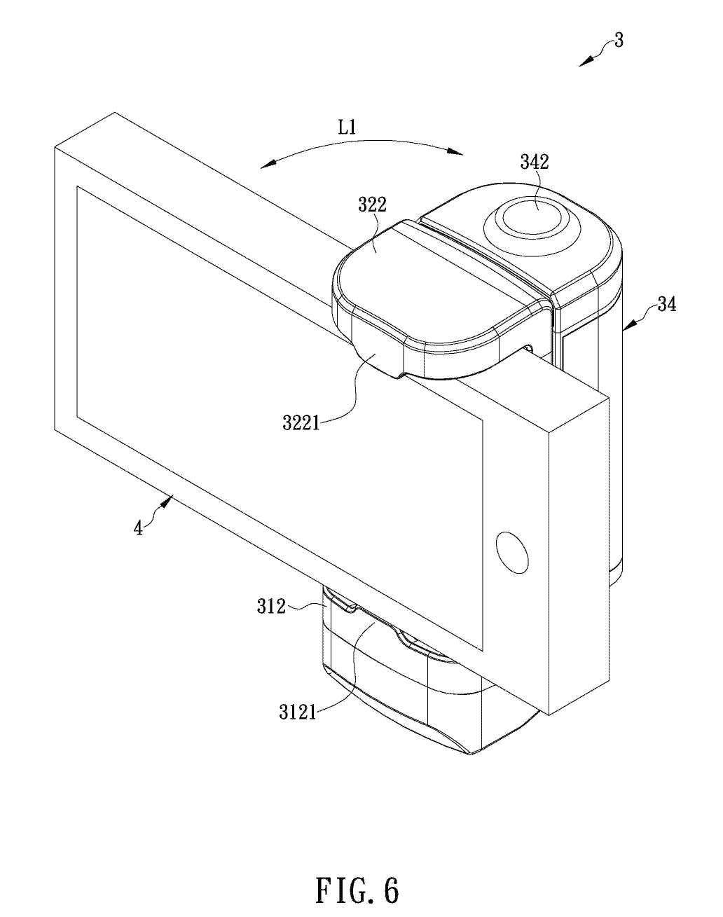

Referring back to FIGS. 3 and 4, the elastic portion 33 includes a mounting base 331 and an elastic restoring member 332. The mounting base 331 is mounted in the fixed portion 31 and corresponds to the bottom edge of the extension base 311. In this embodiment, the mounting base 331 is provided between the first fixed base 31A and the second fixed base 31B and is therefore hidden from view. The elastic restoring member 332 has one end connected to the mounting base 331 and another end connected to the extension plate 321 at a position adjacent to the bottom edge of the extension plate 321. The elastic restoring member 332 can be connected to the extension plate 321 by projection-recess engagement, riveting, or other fixing elements (e.g., screws). Referring to FIGS. 5 and 6, when the user applies a force to the slidable portion 32 to displace it away from the fixed portion 31, the clamping space 310 between the second clamping portion 322 and the first clamping portion 312 expands (see FIG. 5), allowing the user to put a mobile terminal device 4 (e.g., a smartphone or tablet computer) in the clamping space 310. Once the user stops applying the force (i.e., once the applied force is removed), the elastic restoring member 332 generates a restoring force acting on the extension plate 321. The restoring force drives the slidable portion 32 toward the fixed portion 31 and thus reduces the clamping space 310. As a result, with the first clamping portion 312 and the second clamping portion 322 pressing against the two corresponding sides of the mobile terminal device 4 respectively (see FIG. 6), the mobile terminal device 4 is securely clamped between the clamping portions. When the holder 3 is tilted, the mobile terminal device 4 is blocked by the first positioning block 3121 and the second positioning block 3221 and hence kept from damage which may otherwise occurs if the mobile terminal device 4 separates from the holder 3 and falls out of the clamping space 310.

As shown in FIGS. 3 and 4, the controller 34 has one side provided with two rail grooves 341. To mount the controller 34 to the slidable portion 32 and the fixed portion 31, the engaging blocks 323 and the rails 315 are respectively and sequentially received in the rail grooves 341 such that the controller 34 is firmly mounted to the rear side of the extension base 311 and the rear side of the second clamping portion 322. Once the extension plate 321 is fully inserted in the groove 314, the bottom side of the controller 34 is pressed against the top side of the supporting portion 313. When a force is applied to the slidable portion 32 to displace it away from the fixed portion 31, the controller 34 is simultaneously driven away from the supporting portion 313 by the engaging blocks 323. In other embodiments of the present invention, however, the controller 34 can be provided with only one or more than two rail grooves 341, or the controller 34 can be so designed that its bottom side is not pressed against the top side of the supporting portion 313 when the extension plate 321 is fully inserted in the groove 314. If the fixed portion 31 lacks the supporting portion 313, the engaging blocks 323 will drive the controller 34 away from the bottom of the extension base 311 as the slidable portion 32 is displaced away from the fixed portion 31.

Referring again to FIGS. 3 and 4, the controller 34 is configured to make wireless connection with the mobile terminal device 4 (as shown in FIG. 6), wherein the wireless connection can be made according to various wireless communication protocols such as Bluetooth, ZigBee, WiFi, or Near Field Communication (NFC). The top side of the controller 34 is provided with a button 342. When wireless connection is established between the controller 34 and the mobile terminal device 4, pressing the button 342 results in the controller 34 generating a control signal and sending the control signal to the mobile terminal device 4, thus triggering the mobile terminal device 4 to perform a corresponding procedure (e.g., taking a picture). Therefore, when the holder 3 together with the mobile terminal device 4 is to be placed at a distance, or when the user wishes to use a holding stick (by connecting one end of the holding stick to the bottom of the fixed portion 31 and holding the other end of the holding stick), the controller 34 can be detached so that, by pressing the button 342 on the controller 34, the mobile terminal device 4 can be triggered via wireless remote control to take pictures. Furthermore, referring to FIG. 6, the relatively large volume of the controller 34 leads to a large holding space L1 between the mobile terminal device 4 and the controller 34 once the mobile terminal device 4 is mounted to the holder 3. Hence, when it is desired to take pictures with the mobile terminal device 4 within the reach of the arm, the smartphone user can hold the controller 34 directly and conveniently in order to keep the mobile terminal device 4 stable during the picture taking process. It should be pointed out that, referring back to FIGS. 3 and 4, the controller 34 in other embodiments of the present invention can be so designed that it is movably provided on its own at the rear side of the extension base 311, cannot be driven by the slidable portion 32, but can be removed or installed at will according to practical needs. For example, the engaging blocks 323 on the second clamping portion 322 can be dispensed with so that the slidable portion 32 is unable to drive the controller 34 when displaced. Or the rail grooves 341 can be open at both ends in order for the engaging blocks 323 to slide out of the rail grooves 341. In other embodiments of the present invention, it is also feasible to replace the rails 315 of the fixed portion 31, the engaging blocks 323 of the second clamping portion 322, and the rail grooves 341 of the controller 34 with a different structural design, such as an engaging arrangement capable of mounting the controller 34 to the rear side of the extension base 311.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A holder for clamping and wirelessly triggering a mobile terminal device, comprising:
a fixed portion formed with a vertically extending extension base, the extension base having a bottom edge formed with a forwardly extending first clamping portion, the extension base and the first clamping portion being connected together as a single unit;
a slidable portion formed with a vertically extending extension plate, the extension plate having a top edge formed with a forwardly extending second clamping portion, the extension plate and the second clamping portion being connected together as a single unit, the extension plate having a bottom end movably inserted in the extension base such that the extension plate is slidable upward and downward with respect to the extension base, the second clamping portion corresponding to the first clamping portion such that a clamping space in which a mobile terminal device can be clamped is formed between the second clamping portion and the first clamping portion;
an elastic portion comprising a mounting base and an elastic restoring member, the mounting base being mounted in the fixed portion and corresponding to the bottom edge of the extension base, the elastic restoring member having an end connected to the mounting base and another end connected to the extension plate at a position adjacent to the bottom end of the extension plate, wherein when a force is applied to the slidable portion and thereby displaces the slidable portion away from the fixed portion, the clamping space between the second clamping portion and the first clamping portion expands, and once the force is removed, the elastic restoring member generates a restoring force acting on the extension plate and thereby forcing the slidable portion toward the fixed portion; and
a controller having a side movably mounted to a rear side of the extension base, the controller having a top side provided with a button, wherein when wireless connection between the controller and the mobile terminal device is established, pressing the button causes the controller to generate a control signal and send the control signal to the mobile terminal device, thereby triggering the mobile terminal device to perform a corresponding procedure.

2. The holder of claim 1, wherein the extension base has a top edge concavely provided with a groove extending through the extension base, and the bottom end of the extension plate is movably inserted in the groove such that the extension plate is slidable upward and downward along the groove.

3. The holder of claim 2, wherein the fixed portion has a rear side protrudingly provided with at least one rail extending vertically downward from the top edge of the extension base.

4. The holder of claim 3, wherein the side of the controller is provided with at least one rail groove, and the rail is received in the rail groove such that the controller is mounted to the rear side of the extension base.

5. The holder of claim 4, wherein the second clamping portion has a rear side protrudingly provided with at least one engaging block corresponding to and having a same cross-sectional configuration as the rail, and the engaging block and the rail are sequentially received in the rail groove such that the controller is mounted to the rear side of the extension base and the rear side of the second clamping portion, wherein when the extension plate is fully inserted in the groove, a bottom edge of the second clamping portion is pressed against the top edge of the extension base, and a bottom edge of the engaging block is pressed against a top edge of the rail.

6. The holder of claim 5, wherein when the slidable portion is displaced away from the fixed portion, the controller is driven by the engaging block into simultaneous displacement away from the bottom edge of the extension base.

7. The holder of claim 6, wherein the bottom edge of the extension base extends rearward to form a supporting portion, and the extension base and the supporting portion are connected together as a single unit.

8. The holder of claim 7, wherein when the extension plate is fully inserted in the groove, a bottom side of the controller is pressed against a top side of the supporting portion.

9. The holder of claim 5, wherein the first clamping portion has a top side upwardly protrudingly provided with a first positioning block adjacent to a front of the first clamping portion.

10. The holder of claim 6, wherein the first clamping portion has a top side upwardly protrudingly provided with a first positioning block adjacent to a front of the first clamping portion.

11. The holder of claim 7, wherein the first clamping portion has a top side upwardly protrudingly provided with a first positioning block adjacent to a front of the first clamping portion.

12. The holder of claim 8, wherein the first clamping portion has a top side upwardly protrudingly provided with a first positioning block adjacent to a front of the first clamping portion.

13. The holder of claim 9, wherein the second clamping portion has a bottom side downwardly protrudingly provided with a second positioning block adjacent to a front of the second clamping portion.

14. The holder of claim 10, wherein the second clamping portion has a bottom side downwardly protrudingly provided with a second positioning block adjacent to a front of the second clamping portion.

15. The holder of claim 11, wherein the second clamping portion has a bottom side downwardly protrudingly provided with a second positioning block adjacent to a front of the second clamping portion.

16. The holder of claim 12, wherein the second clamping portion has a bottom side downwardly protrudingly provided with a second positioning block adjacent to a front of the second clamping portion.
